(19) United States
(12) Patent Application Publication
(10) Pub. No.: US 2005/0263674 A1
(43) Pub. Date: Dec. 1, 2005

(54) Method and apparatus for adjusting a mixed light produced by first and second light sources of first and second colors

(76) Inventors: Joon-Chok Lee, Kuching (MY); Len-Li Kevin Lim, Taiping (MY); Rizal Jaffar, Masjid Tanah (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/856,509

(22) Filed: May 27, 2004

(51) Int. Cl. G01J 1/32

(52) U.S. Cl. 250/205

(57) ABSTRACT

In one exemplary method, a mixed light is produced using first and second light sources of first and second colors. In one embodiment, the first and second light source are a white light source and a colored (e.g., red) light source. A determination is then made as to whether feedback tristimulus values, representative of the mixed light, are within a range of reference tristimulus values. If one or more of the feedback tristimulus values is out of range, a luminance ratio between the first and second light source is adjusted. In one embodiment, the mixed light is used as a backlight for a liquid crystal display.

### BACKGROUND

Two common backlighting solutions are white light emitting diodes (LEDs) and the cold cathode fluorescent lamp (CCFL). In theory, the wider color gamut of red-green-blue (RGB) LEDs would provide a better backlighting solution. However, factors such as cost, light efficiency and power dissipation are currently prohibiting the effective commercialization of RGB LEDs as a backlighting solution.

### SUMMARY OF THE INVENTION

In one embodiment, a mixed light is produced using first and second light sources of first and second colors. A determination is then made as to whether feedback tristimulus values, representative of the mixed light, are within a range of reference tristimulus values. If one or more of the feedback tristimulus values is out of range, a luminance ratio between the first and second light source is adjusted.

In another embodiment, apparatus comprises a liquid crystal display (LCD), a backlight for the LCD, a sensing system, and a control system. The backlight comprises first and second light sources of first and second colors. The sensing system acquires feedback tristimulus values that are representative of a mixed light produced by the backlight. The control system is provided to 1) determine whether the feedback tristimulus values are within a range of reference tristimulus values, and 2) if one or more of the feedback tristimulus values is out of range, adjust a luminance ratio between the first and second light source.

Other embodiments of the invention are also disclosed.

### BRIEF DESCRIPTION OF THE DRAWINGS

Illustrative and presently preferred embodiments of the invention are illustrated in the drawings, in which:

FIG. 1 illustrates an exemplary method for adjusting a mixed light produced by first and second light sources of first and second colors;

FIG. 2 illustrates a shift in tristimulus values of a light source;

FIG. 3 illustrates potential shifts in tristimulus values of first and second light sources, as well as a range of reference tristimulus values to which a color set point of a bicolor light source can be limited; and

FIG. 4 illustrates exemplary apparatus for adjusting a mixed light produced by first and second light sources of first and second colors.

### DETAILED DESCRIPTION OF AN EMBODIMENT

A backlighting solution that provides wider color gamut than a white light source, but which is more practical to implement than RGB LEDs, is a bicolor light source comprised of first and second light sources of first and second colors. By way of example, the first and second light sources may be a white light source and a colored light source. The white light source can take the form of a CCFL or white LEDs, and the colored light source can take the form of red LEDs (i.e., a red light source).

A problem with backlighting via a bicolor light source is that the optical characteristics of its two light sources may vary with temperature, drive current, aging and other factors. When this occurs, the color of the mixed light produced by the bicolor light source can drift. If one or both of the light sources is implemented using LEDs, differences in LED characteristics can further aggravate the problem of color drift (since LED characteristics can vary from batch to batch within the same fabrication process).

In applications such as liquid crystal display (LCD) backlighting, color consistency and uniformity are very important. A means for adjusting the color of a bicolor light source is therefore needed.

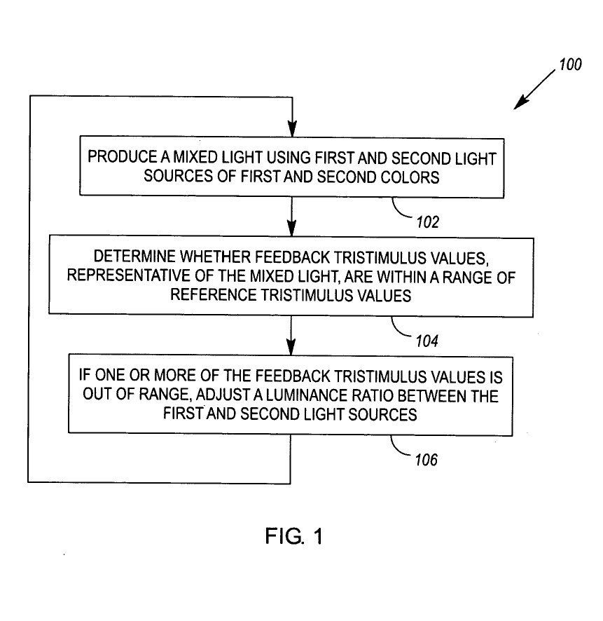

To this end, FIG. 1 illustrates a method 100 wherein a mixed light is produced 102 using first and second light sources of first and second colors. A determination 104 is then made as to whether feedback tristimulus values, representative of the mixed light, are within a range of reference tristimulus values. If one or more of the feedback tristimulus values is out of range, a luminance ratio between the first and second light sources is adjusted 106.

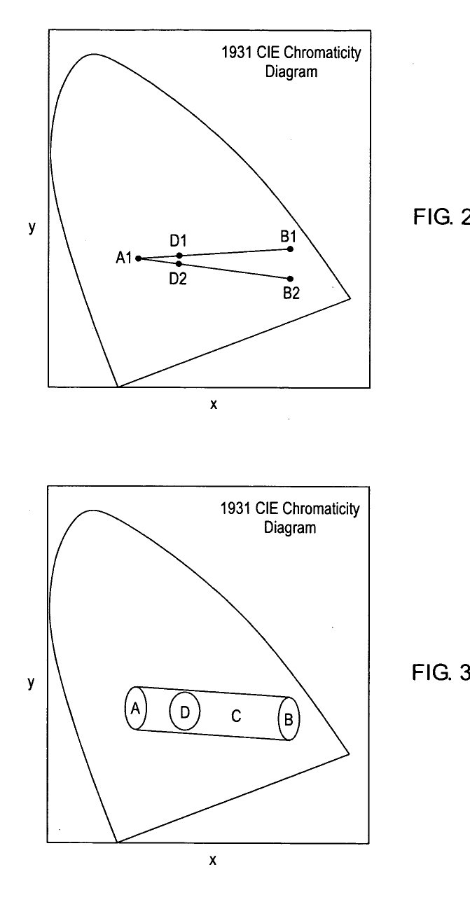

The chromaticity diagrams shown in FIGS. 2 & 3 illustrate the operation of method 100. By way of example, the chromaticity diagrams are shown to be Commission Internationale de l'Éclairage (CIE) 1931 chromaticity diagrams. However, other forms of chromaticity diagrams could be substituted.

In FIG. 1, point A1 is indicative of the tristimulus values of light produced by a white light source at Temperature_1; point B1 is indicative of the tristimulus values of light produced by a red light source at Temperature_1; and point D1 is indicative of a target “color set point” defined by reference tristimulus values.

Now consider a change in the temperature of the red light source, which causes a shift in its tristimulus values. Point B2 is indicative of the tristimulus values of light produced by the red light source at Temperature_2. Due to this change in the tristimulus values of the red light source, color set point D1 is no longer achievable. The closest achievable color is now defined by point D2.

Backlights consisting of only a CCFL or white LEDs assume that the color set point of the backlight is not adjustable, and only the intensity of the backlight is adjustable. On the other hand, backlights comprised of RGB LEDs assume that the backlight's color set point can be precisely defined (i.e., because the intensities of three adjustable light sources (i.e., red, green and blue light sources) can be adjusted to achieve any color set point falling within a triangulated area between the colors of the three light sources). However, neither of these assumptions is applicable to a bicolor light source. This is because, under any given set of conditions under which the first and second light sources operate, each of the light sources produces only a single set of tristimulus values. Thus, the mixed light produced by the two light sources can only be adjusted along a line of colors connecting the two sets of tristimulus values.

If past color setting methods are applied to a bicolor light source, they can result in a control system “hunting” for a color set point that cannot be obtained. To someone viewing a display that is backlit via a bicolor light source, this “hunting” can appear as visible oscillations in the display's color. The method 100 prevents (or at least mitigates) this hunting by adjusting a luminance ratio between first and second light sources only when feedback tristimulus values of a mixed light are “out of range” with respect to reference tristimulus values.

FIG. 3 illustrates how a range of reference tristimulus values may be defined. In this figure, ellipse A is indicative of the tristimulus values through which a white light source might drift (e.g., because of temperature variations or aging). Likewise, ellipse B is indicative of the tristimulus values through which a red light source might drift. Area C, including ellipses A and B, is indicative of the color gamut of the bicolor light source. Absent feedback control, the color of mixed light produced by the bicolor light source could fall anywhere within area C. However, with feedback control, the color set point of the bicolor light source can be limited to the range of tristimulus values within area D. Further, so long as the feedback tristimulus values are within the range D of reference tristimulus values, the first and second light sources need not be adjusted, and unnecessary oscillations of the bicolor light source can be avoided. That is, the goal of method 100 is not to match the feedback tristimulus values to the reference tristimulus values, but to ensure that the feedback tristimulus values are within acceptable limits of the reference tristimulus values.

In one embodiment of the method 100, the range D is established as those values falling within an ellipse about a defined set of reference tristimulus values. The set of reference tristimulus values may be predefined, or may be obtained from user input.

The luminance ratio (i.e., the ratio of the intensity of the first light source in comparison to the intensity of the second light source) may be adjusted in a variety of ways. In one embodiment of the method 100, the luminance ratio is adjusted by adjusting drive signals supplied to the first and second light sources. That is, the intensity of either or both of the light sources may be adjusted. In another embodiment of the method 100, the luminance ratio is adjusted by adjusting a drive signal of only one of the light sources.

The method 100's actions of determining and, if necessary, adjusting may be undertaken continuously or, preferably, at predetermined time intervals.

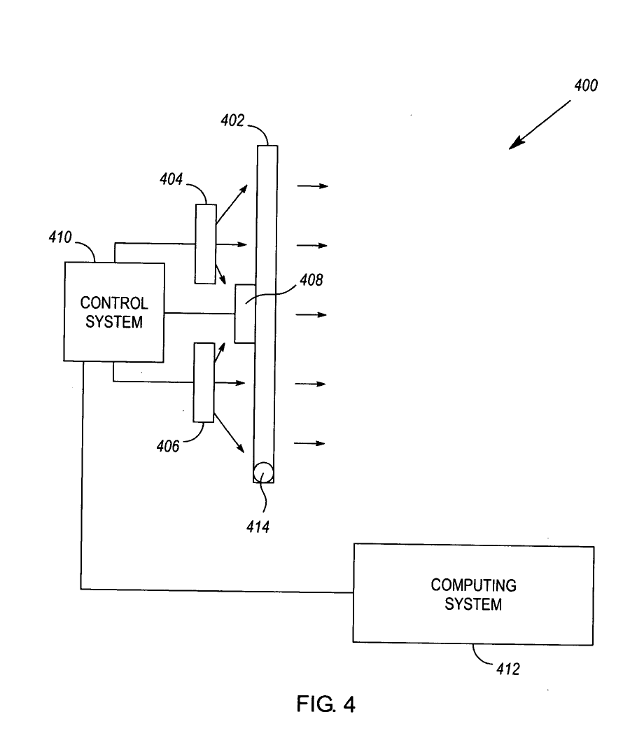

FIG. 4 illustrates the application of method 100 to apparatus 400 comprising a liquid crystal display (LCD) 402, a backlight 404, 406 for the LCD 402, a sensing system 408, and a control system 410. The backlight comprises first and second light sources 404, 406 of first and second colors. The sensing system 408 acquires feedback tristimulus values that are representative of a mixed light produced by the backlight 404, 406. The control system 410 is provided to 1) determine whether the feedback tristimulus values are within a range of reference tristimulus values, and 2) if one or more of the feedback tristimulus values is out of range, adjust a luminance ratio between the first and second light source 404, 406.

In one embodiment, the control system 410 uses fuzzy feedback to determine whether the feedback tristimulus values are within the range of reference tristimulus values.

The apparatus 400 may further comprise a computing system 412 to display a graphical user interface (GUI) on the LCD 402. The GUI may prompt a user to define parameters of images that are generated by the LCD (e.g., color temperature, color intensity, etc.). The computing system 412 then 1) derives a set of reference tristimulus values from the user-defined parameters, and 2) provides the set of reference tristimulus values to the control system 410.

In another embodiment, the apparatus 400 may further comprise a manually-adjustable user control 414 that is coupled to supply the control system 410 with a state of the control. In response to the control's state, the control system 410 may then update its range of reference tristimulus values.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method, comprising:
producing a mixed light using first and second light sources of first and second colors; and
determining whether feedback tristimulus values, representative of said mixed light, are within a range of reference tristimulus values; and
if one or more of the feedback tristimulus values is out of range, adjusting a luminance ratio between said first and second light source.

2. The method of claim 1, wherein said first and second light sources are a white light source and a colored light source.

3. The method of claim 2, wherein the colored light source is a red light source.

4. The method of claim 3, wherein the white light source is a cold cathode fluorescent lamp (CCFL).

5. The method of claim 3, wherein the white light source is a white light emitting diode (LED).

6. The method of claim 1, wherein said light sources are light emitting diode (LED) light sources.

7. The method of claim 1, wherein said luminance ratio is adjusted by adjusting drive signals supplied to the light sources.

8. The method of claim 1, wherein said luminance ratio is adjusted by adjusting a drive signal of only one of the light sources.

9. The method of claim 1, further comprising, establishing said range of reference tristimulus values as those tristimulus values falling within an ellipse about a defined set of reference tristimulus values.

10. The method of claim 9, further comprising, obtaining the defined set of reference tristimulus values from user input.

11. The method of claim 1, wherein said tristimulus values are Commission Internationale de l'Éclairage (CIE) 1931 tristimulus values.

12. The method of claim 1, wherein said actions of determining and, if necessary, adjusting are undertaken at predetermined time intervals.

13. Apparatus, comprising:
a liquid crystal display (LCD);
a backlight for the LCD, the backlight comprising first and second light sources of first and second colors;
a sensing system to acquire feedback tristimulus values representative of a mixed light produced by said backlight;
a control system to i) determine whether said feedback tristimulus values are within a range of reference tristimulus values, and ii) if one or more of the feedback tristimulus values is out of range, adjust a luminance ratio between said first and second light source.

14. The apparatus of claim 13, wherein the control system uses fuzzy feedback to determine whether said feedback tristimulus values are within said range of reference tristimulus values.

15. The apparatus of claim 13, further comprising:
a computing system to i) display a graphical user interface (GUI) on said LCD, said GUI prompting a user to define parameters of images generated by said LCD, ii) derive a set of reference tristimulus values from said parameters, and iii) provide the set of reference tristimulus values to said control system.

16. The apparatus of claim 13, further comprising:
a manually-adjustable user control, said control system receiving a state of said manually-adjustable user control and, in response thereto, updating said range of reference tristimulus values.

17. The apparatus of claim 13, wherein said control system establishes said range of reference tristimulus values as those tristimulus values falling within an ellipse about a defined set of reference tristimulus values.

18. The apparatus of claim 13, wherein said tristimulus values are Commission Internationale de l'Éclairage (CIE) 1931 tristimulus values.

19. The apparatus of claim 13, wherein said first and second light sources are a white light source and a colored light source.

20. The apparatus of claim 19, wherein the colored light source is a red light source.
